(19) United States
(12) Patent Application Publication
(10) Pub. No.: US 2025/0166097 A1
(43) Pub. Date: May 22, 2025

(54) METHOD AND SYSTEM FOR AN AUTOMATED RESTAURANT EXPERIENCE ASSISTANCE FOR A VEHICLE

(71) Applicant: Ford Global Technologies, LLC, Dearborn, MI (US)

(72) Inventors: Brendan F. Diamond, Grosse Pointe, MI (US); Keith Weston, Canton, MI (US); John Robert Van Wiemeersch, Novi, MI (US); Stuart C. Salter, White Lake, MI (US)

(21) Appl. No.: 18/512,229

(22) Filed: Nov. 17, 2023

(51) Int. Cl. G06Q 50/12; B60W 40/08; B60W 60/00; G06Q 10/02; G06V 20/59; G06V 40/16

(52) U.S. Cl. CPC G06Q 50/12; B60W 40/08; B60W 60/00253; G06Q 10/02; G06V 20/59; G06V 40/171; G06V 40/172; B60W 2420/403; B60W 2540/043; B60W 2556/45

(57) ABSTRACT

A method includes detecting, by a vehicle system, at least one passenger in a vehicle, and establishing, by the vehicle system, a communication link with a restaurant that is identified to be visited by the at least one passenger. The method further includes transmitting, by the vehicle system via the communication link, a message to the restaurant to: schedule a reservation at the restaurant for the at least one passenger based on an arrival time to the restaurant in response to detecting that the at least one passenger is going to dine-in at the restaurant, or place a carryout order at the restaurant for the at least one passenger in response to detecting that the at least one passenger is picking up food from the restaurant.

### TECHNICAL FIELD

The present disclosure relates to systems and/or methods for vehicle assist for restaurant experience.

### BACKGROUND

The statements in this section merely provide background information related to the present disclosure and may not constitute prior art.

Advancements in vehicular technology not only includes improving a user's drive experience but also includes providing an overall entertaining and convenient user experience. More particularly, a vehicle infotainment system can be configured to include additional features that assist passengers (e.g., driver and/or other individuals in the vehicle) with tasks, such as, responding to incoming communication, and/or identifying nearby attractions and/or establishments (restaurants.).

### SUMMARY

The statements in this section merely provide background information related to the present disclosure and may not constitute prior art.

In one form, the present disclosure is directed to a method comprising detecting, by a vehicle system, at least one passenger in a vehicle, and establishing, by the vehicle system, a communication link with a restaurant that is identified to be visited by the at least one passenger. The method further includes transmitting, by the vehicle system via the communication link, a message to the restaurant to: schedule a reservation at the restaurant for the at least one passenger based on an arrival time to the restaurant in response to detecting that the at least one passenger is going to dine-in at the restaurant, or place a carryout order at the restaurant for the at least one passenger in response to detecting that the at least one passenger is picking up food from the restaurant.

In one form, the present disclosure is directed to a vehicle system including one or more processors, and a memory storing instructions executable by the one or more processors to cause the one or more processors: detect at least one passenger in a vehicle using image data of a passenger cabin of the vehicle; establish a communication link with a restaurant that is identified to be visited by the at least one passenger; and transmit a message to the restaurant. The message transmitted to the restaurant is to schedule a reservation at the restaurant for the at least one passenger based on an arrival time to the restaurant in response to detecting that the at least one passenger is going to dine-in at the restaurant that the vehicle is traveling to, or place a carryout order at the restaurant for the at least one passenger in response to detecting that the at least one passenger is picking-up food from the restaurant.

In one form, the present disclosure is directed to a vehicle system including a telematics control unit that includes a transceiver and configured to communicate with a restaurant. The vehicle system further includes one or more processors and a memory storing instructions executable by the one or more processors to cause the one or more processors to: detect at least one passenger in a vehicle using image data of a passenger cabin of the vehicle; establish a communication link with a restaurant that is identified to be visited by the at least one passenger via the TCU; detect whether the at least one passenger is going to dine-in at or carryout from the restaurant based on at least one of a restaurant type of the restaurant, a historical data of the at least one passenger, or an input from the at least one passenger indicating the at least one passenger is to dine-in; and transmit a message to the restaurant. The message transmitted to the restaurant is to schedule a reservation at the restaurant for the at least one passenger based on an arrival time to the restaurant in response to detecting that the at least one passenger is going to dine-in at the restaurant that the vehicle is traveling to, or place, in response to detecting that the at least one passenger is picking-up food from the restaurant, a carryout order at the restaurant for the at least one passenger when a preparation time of the carryout order, received by the restaurant, is greater than or equal to an estimated travel time of the vehicle. The arrival time is based on the estimated travel time of the vehicle, an estimated parking time, and an estimated walking time to the restaurant.

### BRIEF DESCRIPTION OF THE DRAWINGS

In order that the disclosure may be well understood, there will now be described various forms thereof, given by way of example, reference being made to the accompanying drawings, in which:

FIG. 1 illustrates a vehicle having a restaurant assist module in communication with a restaurant in accordance with the present disclosure;

FIG. 2 is an example block diagram of a vehicle system of the vehicle of FIG. 1 in accordance with the present disclosure; and

FIG. 3 is a flowchart of an example restaurant assist routine in accordance with the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Routine experiences like going to a restaurant can require different tasks like making reservations when dining in or placing a carryout order. Often, people may go to the same restaurants and may even have the same order. At times, a person may need to wait in line before placing their order, and if they order in advance, they must time the order so that the food is freshly made and not cold. Even more, such tasks can become difficult to time and manage especially when it is difficult to assess arrival time for a reservation and/or preparation time of an order.

In one form, the present disclosure is directed to a vehicle having a restaurant assist module for assisting passengers with their restaurant experience. More particularly, with the vehicle in communication with the restaurant and using devices in the vehicle, the restaurant assist module is configured to detect whether the passenger is going to dine-in or carryout from the restaurant. If dining-in, the restaurant assist module is configured to schedule a reservation at the restaurant for the passenger based on an arrival time, and if carrying out, the restaurant assist module is configured to place a carryout order at the restaurant for the passenger based on a travel time of the vehicle 100. The restaurant assist module automates routine tasks for the passenger to provide an enhanced restaurant experience.

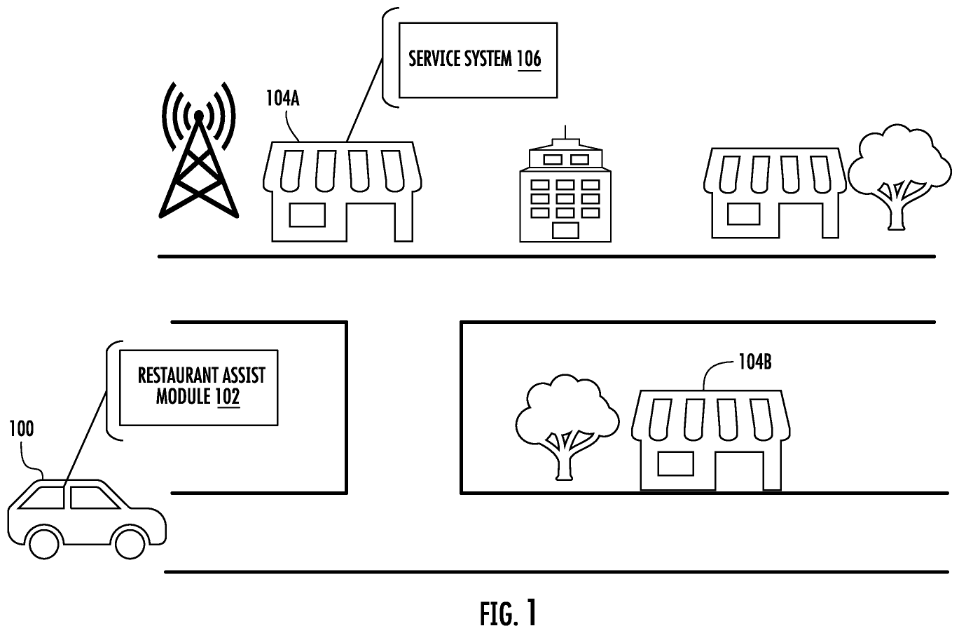

Referring to FIG. 1, a vehicle 100 includes a restaurant assist module 102 configured to automate various tasks related a restaurant experience. More particularly, the vehicle 100 is configured to communicate with a restaurant 104A and 104B (collectively “restaurants 104”) and specifically, a service system 106 of the restaurant 104.

In one form, the service system 106 of the restaurant 104 is configured to manage dine-in and carryout experiences, such as, but not limited to, managing reservations, placing dine-in orders, accepting and executing carryout orders, and notifying customers of the status/completion of an order. In addition, using infrastructure-to-everything communication (I2X), the service system 106 is configured to communicate with external devices such as, but not limited to, the vehicle 100 via a communication link. The service system 106 may include a server (local and/or cloud-based server), one or more computing devices configured to interface with a user (e.g., restaurant employee) to access data/functions supported by the server, and/or communication devices (e.g., modems, transceivers, and/or one or more controller configured to execute one or more communication protocols (e.g., transmission control protocol (TCP), cellular protocols, I2X protocol, among others)).

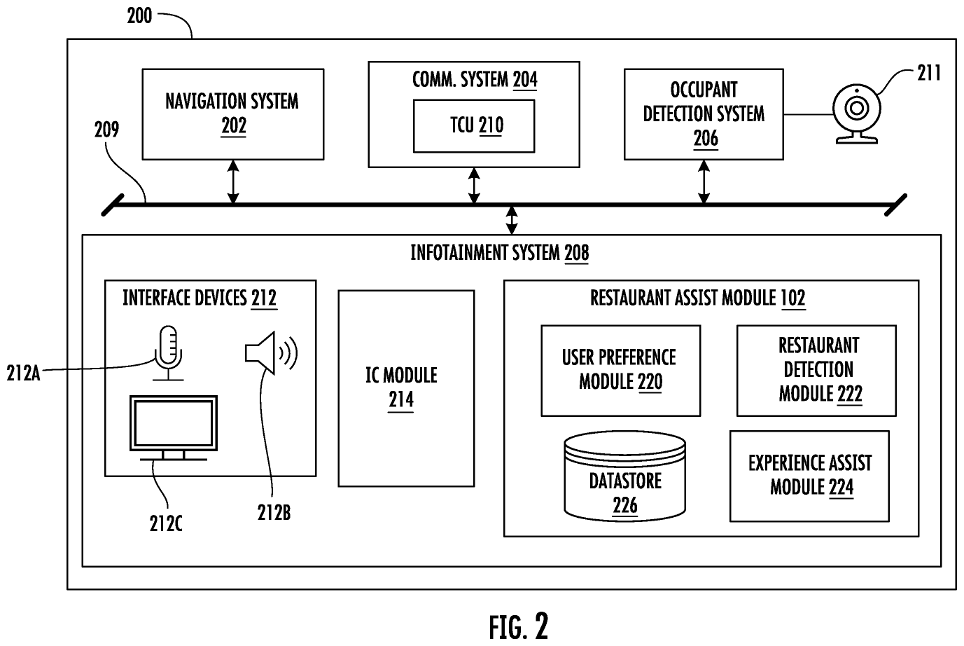

Referring to FIG. 2, the vehicle 100 includes a vehicle system 200 that includes a navigation system 202, a communication system 204, an occupant detection system 206, and an infotainment system 208. While specific systems are provided, the vehicle system 200 may include other systems such as, but not limited to, a climate control system, a powertrain system, and/or adaptive drive system. In one form, the navigation system 202, the communication system 204, the occupant detection system 206, and the infotainment system 208 are in communication with each other via a vehicle network 209 (e.g., a controlled access network).

In one form, the communication (Comm.) system 204 is configured to communicate with various external devices/systems, such as, but not limited to, the service system 106 of the restaurant 104, cellular network, other vehicles. The communication system 204 may also communicate with devices within the vehicle 100 such as, but not limited to, a portable computing device (PCD) (e.g., a smartphone and/or tablet) via wireless or wired communication links. Accordingly, among other components, the communication system 204 includes a telematics control unit (TCU) 210 that is configured to establish communication under vehicle-to-everything (V2X) protocol, a BLUETOOTH transceiver to communicate with devices using BLUETOOTH protocol, a global navigation satellite system (GNSS) receiver, and/or an ultra-wideband (UWB) transceiver.

In one form, the navigation system 202 is configured to track a location of the vehicle 100, define a travel route based on a desired destination, provide directions to the desired destination based on the travel route defined, and/or estimate travel time of the vehicle 100 to the desired destination. Among other components, the navigation system 202 includes a GNSS receiver, a map library, and/or navigation algorithms for defining the travel route. In some variations, the navigation system 202 is supported by the PCD provided in the vehicle 100, in lieu of or in addition to a separate dedicated navigation system 202 installed within the vehicle 100. Specifically, the PCD is configured to include one or more route guidance software applications that the passenger may employ to go to a desired destination. With the PCD in communication with the vehicle 100 via the communication system 204, various modules/systems may access information related to the guidance software, such as, but not limited to the infotainment system 208. Accordingly, the navigation system 202 of the vehicle system 200 may be supported and implemented by the PCD.

The occupant detection system 206 is configured to detect passenger(s) within the vehicle 100 using data from an occupant detection sensor, such as a camera 211, and known image processing techniques. For example, the occupant detection system 206 obtains images of the passenger cabin of the vehicle 100 and determines whether there is a passenger in the cabin using known image processing techniques. In a non-limiting example, the image processing software application includes facial detection algorithms to detect the passenger and obtain facial characteristics (i.e., facial feature data) of the passenger. The occupant detection system 206 may also track the number of passengers detected and the facial feature data associated with each passenger. In some variations, in lieu of or in addition to the image data, a passenger may be identified based on the presence of a PCD paired with the vehicle 100.

The infotainment system 208 is configured to provide information and access to various auxiliary features, such as, but not limited to, the navigation system 202 and the restaurant assist module 102. In one form, the infotainment system 208 includes one or more user interface (UI) devices 212 and an infotainment control (IC) module 214 configured to exchange information with the passenger and control a selected auxiliary feature based on an input from the passenger received via the UI devices 212. In one form, the UI devices 212 includes audio devices (e.g., microphone 212A and/or speaker 212B), display device 212C (e.g., a head-up display and/or a liquid crystal display with touchscreen), and/or other suitable input devices (e.g., buttons, knobs, etc.).

The IC module 214 is configured provide information to the passenger via the UI devices 212, such as, but not limited to, a menu of available auxiliary features that can be accessed and controlled using the UI devices 212. In a non-limiting example, the IC module 214 is configured to have a voice activated control that employs the audio devices to communicate with the passenger and/or display graphical interfaces on the display device 212C. Based on the inputs received, the IC module 214 may provide information regarding the input to a respective system of the vehicle 100. For example, and as described herein, the IC module 214 provides inquiries or information associated with the restaurant assist module 102 to the passenger via the UI devices 212 and provides information to the restaurant assist module 102 based on the inputs from the passenger.

In one form, the restaurant assist module 102 is configured to include a user preference module 220, a restaurant detection module 222, and an experience assist module 224. The user preference module 220 is configured to generate and store data related to one or more users of the restaurant assist module 102. The data is stored as a user record in a user profile datastore 226. Specifically, using the IC module 214, the user preference module 220 is configured to request information from the user using the UI devices 212 (e.g., ask questions via audio devices and/or display devices). In a non-limiting example, the requested information may include a user identification (e.g., name); image data employed by the restaurant assist module 102 to identify the user when the user is a passenger in the vehicle 100; information regarding PCD associated with the passenger (e.g., PCD make/model, unique alphanumeric identification); and/or information related to restaurants 104 (e.g., names and/or addresses of preferred restaurants 104 preidentified by the user, restaurants 104 visited by the user when in the vehicle 100, and/or preferred cuisines). The user preference module 220 may also save information related to restaurants 104 visited by the passenger based on desired destinations tracked by the navigation system 202. In some forms, the user profile datastore 226, which stores the user record(s), may be provided in the vehicle 100 or even a cloud-based server accessible by the vehicle 100.

The user preference module 220 is further configured to identify the passenger in response to the occupant detection system 206 detecting the passenger. In a non-limiting example, the user preference module 220 obtains facial feature data related to the passenger from the occupant detection system 206, and compares the data to prestored facial feature data of one or more users provided in the user record(s) in the user profile datastore 226. If multiple passengers are detected, the user preference module 220 identifies each passenger. If the facial feature data matches one of the prestored facial feature data, the user preference module 220 identifies the passenger and retrieves the user record for the identified passenger. If the facial feature data does not match one of the prestored facial feature data, the passenger is not identified and the user preference module 220 may present options for setting up a user record to the passenger using the IC module 214.

In some applications, in lieu of having a dedicated user preference module 220, the restaurant assist module 102 may employ a preexisting user/passenger identification system in the vehicle 100 that stores information related to the user. The preexisting user identification system may be modified to include information related to restaurants 104. Such preexisting user/passenger identification system may also be provided in a cloud-based server accessible by the vehicle 100.

In one form, the restaurant detection module 222 is configured to detect whether the vehicle 100 is traveling to the restaurant 104 and if so, whether the experience at the restaurant 104 is to be dine-in or carryout. More particularly, the restaurant detection module 222 may present an inquiry to the passenger asking if he/she is going to the restaurant 104 using the IC module 214. If so, the restaurant detection module 222 requests information related to the restaurant 104 such as, but not limited to, name and/or address. In another example, the restaurant detection module 222 is configured to detect that the passenger is going to the restaurant 104 based on the desired destination provided by the passenger to the navigation system 202.

If the vehicle 100 is traveling to the restaurant 104, the restaurant detection module 222 determines if the passenger intends to dine-in or carryout. In a non-limiting example, the restaurant detection module 222 determines whether the experience at the restaurant 104 is dine-in or carryout based on at least one of: a restaurant type of the restaurant 104 (e.g., a fast food restaurant may be inferred to be a carryout establishment); historical data, if available in the user record, of the passenger that indicates a pattern of the passenger (e.g., whether the passenger historically dines in or does carryout at the specific restaurant 104, whether the passenger has a pattern of just dining in or just carrying out at any restaurant 104); and/or presenting an inquiry asking if the passenger intends to dine-in or carryout.

In some variations, if the restaurant detection module 222 determines that the destination is not the restaurant 104, the restaurant detection module 222 may determine if the destination is longer than a defined travel duration indicative of a long travel that may require one or more stops. For example, if the desired destination is more than 3 hours away, the restaurant detection module 222 is configured to recommend restaurants 104 that are on route to the selected destination after the vehicle 100 has traveled a predefined time (e.g., 1.5 hr.) or a predefined distance without stopping. In one form, the restaurants 104 recommended are within a selected distance from the vehicle 100 or the travel route, and may be selected based on information related to restaurants 104 provided in the user record, if available. In some variations, once the restaurant detection module 222 determines that the destination is longer than a defined travel duration, the restaurant detection module 222 may present an inquiry asking if the passenger would be interested in restaurant recommendations along the route prior to providing the recommendations.

The experience assist module 224 is configured to assist the passenger with the restaurant experience whether it is dine-in or carryout. More particularly, in one form, if the passenger is planning to dine-in, the experience assist module 224 is configured to schedule a reservation at the restaurant 104 for the passenger based on an arrival time of the passenger. In a non-limiting example, the experience assist module 224 determines the number of people for the reservation based on the number of passengers in the vehicle 100 and/or an inquiry to the passenger asking or verifying the number of people for the reservation. In some forms, with the communication system 204 communicating with the service system 106 of the restaurant 104 using V2X protocols, and the experience assist module 224 is configured to notify or exchange messages with the restaurant 104 via the communication system 204.

In one form, the experience assist module 224 estimates the arrival time of the passenger at the restaurant 104 based on an estimated travel time of the vehicle 100 and if available, supplemental data, such as, but not limited, to an estimated parking time (e.g., time it takes to park the vehicle 100), and/or an estimated walking time to the restaurant 104 from the vehicle 100. In some variations, the experience assist module 224 obtains information regarding whether the restaurant 104 has available parking and/or valet from the restaurant 104 via the communication system 204. In some variations, the desired destination may be a parking structure/lot and the experience assist module 224 estimates arrival time based on the estimate travel time to the parking structure/lot and time it takes the passenger to walk to the restaurant 104 from the parking lot/structure.

If the restaurant 104 has valet service, the experience assist module 224 is further configured to notify the restaurant 104 of the vehicle 100 approaching the restaurant 104 to notify the valet service that the vehicle 100 will be arriving. In addition, when the dine-in experience is coming to an end, the passenger can inform the vehicle 100 using the PCD associated with the passenger, which may communicate with the vehicle 100 using known vehicle service software applications. The experience assist module 224 may then inform the restaurant 104, so that the valet attendant may retrieve the vehicle 100. In another variation, the experience assist module 224 is configured to track a position of the passenger using the vehicle service software application on the PCD, and if position indicates the passenger is leaving (e.g., walking away from the table to an entrance), the experience assist module 224 provides the notification to the restaurant 104 to have the valet attendant retrieve the vehicle 100.

In some variations, the vehicle 100 may have a phone as a key (PAAK) capability in which the vehicle service software application provided on a PCD is configured to provide access to the vehicle 100. With this feature, the experience assist module 224 is further configured to provide a temporary PAAK access to have the valet perform selected functions (e.g., unlock the doors of the vehicle 100, turn on the vehicle 100, and drive the vehicle 100), until the passenger returns to the vehicle 100 and is detected as the authorized owner via, for example, the vehicle service software application.

The experience assist module 224 is further configured to assist the passenger when the passenger intends to place a carryout order with the restaurant 104. Specifically, the experience assist module 224 is configured to obtain a carryout order from the passenger and by communicating with the restaurant 104, obtains a preparation time for the carryout order. The experience assist module 224 then estimates a travel time of the vehicle 100 to the restaurant 104 using information from the navigation system 202, and places the carryout order when the preparation time is greater than or equal to the travel time of the vehicle 100. This may reduce the amount of time that the food for the carryout order is sitting waiting for the passenger.

In one form, the experience assist module 224 is configured to obtain the carryout order in various suitable ways. In a non-limiting example, the experience assist module 224: using the IC module 214, presents an order inquiry by displaying a menu from the restaurant 104 and requests items to be ordered using the IC module 214; and/or displays a recommended order based on previous orders associated with the passenger and requests the passenger to approve/modify the recommended order using the IC module 214. The recommended order may be generated based on historical information provided in the user record and/or on previous orders on food related software applications on the PCD associated with the passenger.

When at least two passengers are detected, the experience assist module 224 is configured to stagger the carryout order if one order will take longer than other orders. More particularly, the experience assist module 224 obtains a preparation time for each carryout order, estimates a travel time of the vehicle 100 to the restaurant 104, and places the carryout orders based on the preparation time for the order and the travel time, so to reduce or minimizes the time the carryout order is waiting for the passenger.

In some variations, the experience assist module 224 is further configured to determine if the restaurant 104 is able to fulfil the carryout order. Specifically, prior to sending the carryout order, the experience assist module 224 inquires whether the restaurant 104 is able to make the food provided in the carryout order. If so, the experience assist module 224 provides the official carryout order when the preparation time is greater than or equal to the travel time of the vehicle 100. In response to receiving a message from the restaurant 104 that at least one item of the carryout order cannot be fulfilled, the experience assist module 224 is configured to notify the passenger that at least one item of the carryout order is unavailable. The passenger may then be able to change his/her order and/or provide a different restaurant 104 that they would like to order from.

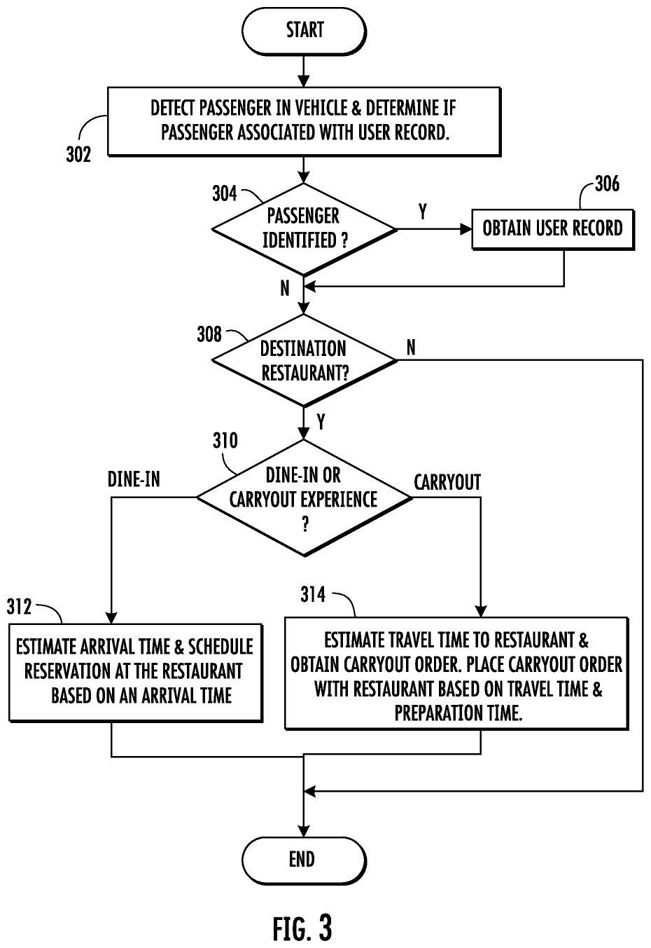

Referring to FIG. 3, an example restaurant assist routine 300 is executed by the vehicle system 200 having the restaurant assist module 102. At operation 302, the vehicle system 200 detects a passenger in the vehicle 100 and determines whether the passenger is associated with a user record of the restaurant assist module 102. In a non-limiting example, using image data of the passenger cabin and known image processing techniques, the vehicle system 200 detects the presence of a passenger. Once detected, the vehicle system 200 compares facial feature data of the passenger with the prestored facial features of user(s) that are associated with the restaurant assist module 102. If the passenger is identified (i.e., a user record is associated with the passenger), the vehicle system 200 obtains the user record from the datastore 226 at operation 306.

After obtaining the user record or not being able to identify the passenger, the vehicle system 200 determines if the destination is the restaurant 104 at operation 308 based on, as detailed above, a desired destination entered to the navigation system 202 and/or by providing an inquiry to the passenger. If the destination is not the restaurant 104, the routine 300 ends. If the destination is the restaurant 104, the vehicle system 200 determines if the restaurant experience is dine-in or carryout, at operation 310, as detailed above.

If the experience is dine-in, the vehicle system 200, at operation 312, estimates an arrival time of the passenger and schedules a reservation at the restaurant 104 based on the arrival time. That is, the vehicle system 200 communicates with the service system 106 of the restaurant 104 to schedule the reservation close to a time that the passenger is to arrive at the restaurant 104. As detailed above, the arrival time may be determined using the travel time of the vehicle 100, an estimated parking time to park the vehicle 100, and an estimate walking time to the restaurant 104 from the vehicle 100.

If the experience is carryout, the vehicle system 200, at operation 314 and as detailed above, estimates a travel time of the vehicle 100 to the restaurant 104, obtains a carryout order, and places the carryout order based on the travel time and the preparation time of the carryout order. If multiple orders are being placed, the vehicle system 200 is configured to stagger the carryout to reduce or minimize the time that the food is waiting for the passenger.

The restaurant assist routine 300 may be configured to perform other operations within the scope of the present disclosure, and should not be limited to the example described herein. For example, after determining that the destination is not the restaurant 104, the vehicle system 200 is configured to recommend restaurants 104 to the passenger upon detecting that the vehicle 100 has traveled a predefined time or a predefined distance without stopping. In another example, the vehicle system 200 is configured to notify a valet service of the restaurant 104 to obtain the vehicle 100 when the passenger is believed to be finished with his/her meal.

Among other improvements/features, the vehicle system 200 having the restaurant assist module 102 improves automated systems employed by individuals and the restaurants for scheduling reservations and even placing food orders. Specifically, the restaurant assist module 102 is configured to use the occupant detection system 206 to detect and identify passenger in the vehicle 100 and obtain a user profile record for the passenger, if available. By automatically detecting passengers and using the information in the associated user profile record, the restaurant assist module 102 may reduce the time it takes the passenger and the existing automated system to schedule a reservation or place a carryout order. In some forms, the restaurant assist module 102 is able to present recommendations to the passenger based on the information in the user profile record, which may include historical data of the restaurants visited and/or the food items ordered/preferred by the user/passenger.

Furthermore, the restaurant assist module 102 is configured to use the navigation system 202 to monitor the travel time of the vehicle 100 to the restaurant. This may improve the accuracy of the actual arrival time/travel time employed to schedule reservations and/or place carryout orders, and thus, improve accuracy of reservation scheduling systems to limit wait time or loss of reservation and/or improve carryout order systems at restaurants by scheduling food prep with more realistic arrivals/pick-up.

In some forms, the restaurant assist module 102 is also configured to provide an automated valet service by detecting when a passenger, who is currently a patron at the restaurant, is leaving and transmitting a message to the restaurant to have the vehicle 100 retrieved from the parking space. This may increase the efficiency of the valet service and reduce wait time of the passenger.

While the present disclosure is directed to timing the arrival of the vehicle 100 with respect to an order at the restaurant 104, the teachings of the disclosure may also be applicable to other establishments, such as, but not limited to a pharmacy. In a non-limiting example, the vehicle 100 communicates with the pharmacy to determine how long it would take to refill a prescription and then places the refill order when the preparation time of the refill order is greater than or equal to a travel time of the vehicle 100. Information regarding the pharmacy and prescription may be stored in the user record.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

In this application, the term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

What is claimed is:

1. A method comprising:
detecting, by a vehicle system, at least one passenger in a vehicle;
establishing, by the vehicle system, a communication link with a restaurant that is identified to be visited by the at least one passenger; and
transmitting, by the vehicle system via the communication link, a message to the restaurant to:
schedule a reservation at the restaurant for the at least one passenger based on an arrival time to the restaurant in response to detecting that the at least one passenger is going to dine-in at the restaurant, or
place a carryout order at the restaurant for the at least one passenger in response to detecting that the at least one passenger is picking up food from the restaurant.

2. The method of claim 1, further comprising detecting, by the vehicle system, that the at least one passenger is going to dine-in at the restaurant based on at least one of a restaurant type of the restaurant, a historical data of the at least one passenger, or an input from the at least one passenger indicating the at least one passenger is to dine-in.

3. The method of claim 1, further comprising estimating, by the vehicle system, the arrival time based on an estimated travel time of the vehicle, an estimated parking time, and an estimated walking time to the restaurant.

4. The method of claim 1, wherein to place the carryout order the method further includes:
obtaining, by the vehicle system via the communication link, a preparation time for the carryout order; and
estimating, by the vehicle system, a travel time of the vehicle to the restaurant, wherein the message is transmitted to place the carryout order when the preparation time of the carryout order is greater than or equal to the travel time of the vehicle.

5. The method of claim 1, wherein when at least two passengers are detected, the method further includes:
obtaining, by the vehicle system, a preparation time for the carryout order for each of the at least two passengers from the restaurant; and
estimating, by the vehicle system, a travel time of the vehicle to the restaurant, wherein the message is transmitted to place each carryout order when the preparation time of a respective carryout order is greater than or equal to the travel time of the vehicle.

6. The method of claim 1, further comprising:
identifying, by the vehicle system, at least one user among the at least one passenger detected based on one or more user records stored in a datastore characteristics of the at least one passenger including at least one of a portable computing device associated with the passenger, facial features identified from image data, or a combination thereof; and
recommending, by the vehicle system, a food item for the carryout order based on a user record associated with the at least one user identified.

7. The method of claim 1, further comprising providing, by the vehicle system, a recommendation of one or more restaurants provided within a selected distance from the vehicle upon detecting that the vehicle has traveled a predefined time or a predefined distance without stopping.

8. The method of claim 1, further comprising notifying, by the vehicle system, the at least one passenger that at least one item of the carryout order is unavailable in response to receiving a message from the restaurant that the at least one item cannot be fulfilled.

9. The method of claim 1, further comprising notifying, by the vehicle system, the restaurant to request a valet service associated with the restaurant to retrieve the vehicle in response to detecting that a patron at the restaurant is ready to leave, wherein the patron is the passenger detected.

10. A vehicle system comprising:
one or more processors;
a memory storing instructions executable by the one or more processors to cause the one or more processors:
detect at least one passenger in a vehicle using image data of a passenger cabin of the vehicle;
establish a communication link with a restaurant that is identified to be visited by the at least one passenger; and
transmit a message to the restaurant to:
schedule a reservation at the restaurant for the at least one passenger based on an arrival time to the restaurant in response to detecting that the at least one passenger is going to dine-in at the restaurant that the vehicle is traveling to, or
place a carryout order at the restaurant for the at least one passenger in response to detecting that the at least one passenger is picking-up food from the restaurant.

11. The vehicle system of claim 10, wherein the instructions further cause the one or more processors to detect that the at least one passenger is going to dine-in at the restaurant based on at least one of a restaurant type of the restaurant, a historical data of the at least one passenger, or an input from the at least one passenger indicating the at least one passenger is to dine-in.

12. The vehicle system of claim 10, wherein the instructions further cause the one or more processors to estimate the arrival time based on an estimated travel time of the vehicle, an estimated parking time, and an estimated walking time to the restaurant.

13. The vehicle system of claim 10, wherein to place the carryout order, the instructions further cause the one or more processors to:
obtain a preparation time for the carryout order; and
estimate a travel time of the vehicle to the restaurant, wherein the message is transmitted to place the carryout order when the preparation time of the carryout order is greater than or equal to the travel time of the vehicle.

14. The vehicle system of claim 10, wherein when at least two passengers are detected, the instructions further cause the one or more processors to:
obtain a preparation time for the carryout order for each of the at least two passengers; and
estimate at least one travel time of the vehicle to the restaurant, wherein the message is transmitted to place each carryout order when the preparation time of a respective carryout order is greater than or equal to the travel time of the vehicle.

15. The vehicle system of claim 10, wherein the instructions further cause the one or more processors to:
identify at least one user among the at least one passenger detected based on one or more user records stored in a datastore and on facial features identified from the image data, and
recommend a food item for the carryout order based on a user record associated with the at least one user identified.

16. The vehicle system of claim 10, wherein the instructions further cause the one or more processors to provide a recommendation of one or more restaurants provided within a selected distance from the vehicle upon detecting that the vehicle has traveled a predefined time or a predefined distance without stopping.

17. The vehicle system of claim 10, wherein the instructions further cause the one or more processors to notify the at least one passenger that at least one item of the carryout order is unavailable in response to receiving a message from the restaurant that the at least one item cannot be fulfilled.

18. The vehicle system of claim 10, wherein the instructions further cause the one or more processors to notify the restaurant to request a valet service associated with the restaurant to retrieve the vehicle in response to detecting that a patron at the restaurant is ready to leave, wherein the patron is the passenger detected.

19. A vehicle system comprising:
a telematics control unit including a transceiver and configured to communicate with a restaurant;
one or more processors;
a memory storing instructions executable by the one or more processors to cause the one or more processors:
detect at least one passenger in a vehicle using image data of a passenger cabin of the vehicle;
establish a communication link with a restaurant that is identified to be visited by the at least one passenger;
detect whether the at least one passenger is going to dine-in at or carryout from the restaurant based on at least one of a restaurant type of the restaurant, a historical data of the at least one passenger, or an input from the at least one passenger indicating the at least one passenger is to dine-in; and
transmit a message to the restaurant to:
schedule a reservation at the restaurant for the at least one passenger based on an arrival time to the restaurant in response to detecting that the at least one passenger is going to dine-in at the restaurant that the vehicle is traveling to, wherein the arrival time is based on an estimated travel time of the vehicle, an estimated parking time, and an estimated walking time to the restaurant, or
place, in response to detecting that the at least one passenger is picking-up food from the restaurant, a carryout order at the restaurant for the at least one passenger when a preparation time of the carryout order, received by the restaurant, is greater than or equal to the estimated travel time of the vehicle.

20. The vehicle system of claim 19, wherein the instructions further cause the one or more processors to provide a recommendation of one or more restaurants provided within a selected distance from the vehicle upon detecting that the vehicle has traveled a predefined time or a predefined distance without stopping.
